(19) United States
(12) Patent Application Publication
(10) Pub. No.: US 2024/0273058 A1
(43) Pub. Date: Aug. 15, 2024

(54) Domain Adaptive Processor For Wireless Communication

(71) Applicant: THE REGENTS OF THE UNIVERSITY OF MICHIGAN, Ann Arbor, MI (US)

(72) Inventors: Hun-seok KIM, Ann Arbor, MI (US); David BLAAUW, Ann Arbor, MI (US); Kuan-Yu CHEN, Ann Arbor, MI (US)

(73) Assignee: THE REGENTS OF THE UNIVERSITY OF MICHIGAN, Ann Arbor, MI (US)

(21) Appl. No.: 18/439,936

(22) Filed: Feb. 13, 2024

Related U.S. Application Data
(60) Provisional application No. 63/445,406, filed on Feb. 14, 2023.

(51) Int. Cl. G06F 15/80; G06F 9/30

(52) U.S. Cl. CPC G06F 15/8046; G06F 9/30065

(57) ABSTRACT

A domain adaptive systolic-array-processor is presented with 256 programmable cores in a 12 nm CMOS for wireless communication workloads. The domain adaptive processor uses a globally homogeneous but locally heterogeneous architecture, decode-less reconfiguration instructions for data streaming, single-cycle data communication between functional units (FUs), and lightweight nested-loop control. This disclosure shows how configuration flexibility and fast program loading allows a wide range of communication workloads to be mapped and swapped in sub-μs, supporting continually evolving communication standards such as 5G. The domain adaptive processor achieves 507 GMACs/J and a peak performance of 264 GMACs.

### CROSS-REFERENCE TO RELATED APPLICATIONS

This application claims the benefit of U.S. Provisional Application No. 63/415,406, filed on Feb. 14, 2023. The entire disclosure of the above application is incorporated herein by reference.

### GOVERNMENT CLAUSE

This invention was made with government support under FA8650-18-2-7860 awarded by the U.S. Air Force. The government has certain rights in the invention.

### FIELD

The present disclosure relates to a domain adaptive processor for wireless communication.

### BACKGROUND

With the increased use of accelerators to augment general purpose and GPGPU processing, the trade-off between efficiency and flexibility has become a key concern. The need for flexibility is particularly pertinent for wireless communication workloads where new standards are frequently introduced and require modification of computational kernels. These workloads are characterized by data streaming which make them especially suitable for systolic-array architectures which can achieve high efficiency but traditionally have limited flexibility.

To address this issue, this disclosure proposes a domain adaptive processor that implements a configurable systolic-array fabric designed to execute a wide range of wireless communication kernels with near-ASIC energy efficiency.

This section provides background information related to the present disclosure which is not necessarily prior art.

### SUMMARY

This section provides a general summary of the disclosure, and is not a comprehensive disclosure of its full scope or all of its features.

A domain adaptive computer processor is presented. The domain adaptive processor is comprised of at least one set of management units; and a systolic array of processing elements connected to the set of management units. Each processing element in the systolic array of processing elements includes: one or more functional units; at least four ports for passing data between adjacent processing elements; at least one register interfaced with the one or more functional units; an instruction memory and a loop control unit. The instruction memory stores instructions, such that each instruction specifies an operation to be performed by the processing element and the specified operation is defined by a configuration for the data flow between components comprising the processing element, and a number of cycles the configuration is implemented by the processing element. The loop control unit is configured to retrieve portion of a given instruction from the instruction memory and coordinate execution of the given instruction according to the number of cycles specified by the given instruction.

In one aspect, the loop control unit coordinates execution of two or more loops, where each loop is a set of sequentially executed instructions.

In another aspect, each processing element in the systolic array of processing elements further includes a register unit, where the register unit is configured to retrieve portion of the given instruction from the instruction memory and implement the configuration for the data flow between components specified in the given instruction. The types of configurations specified in the given instruction are selected from a group consisting of changing an operating mode of a functional unit, changing dataflow between components, changing loop number, directly writing a value to the at least one register, and directly moving data from the at least one register.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram of an example architecture for a domain adaptive computer processor.

FIG. 2 is a block diagram of an example implementation for a processing element in the systolic array of processing elements.

FIG. 3 depicts an example data format for an instruction.

FIG. 4 is a schematic for an example embodiment of a processing element.

FIG. 5 is a block diagram showing a loop control unit of a processing element.

FIG. 6 illustrates an example sequence of instructions with embedded loop processing.

FIGS. 7-11 further illustrate the nested loop control technique in accordance with the instruction sequence shown in FIG. 6.

FIG. 12 is a diagram depicting a mapping for the systolic array of processing elements to perform 2D convolution.

FIG. 13 is a diagram showing a high level mapping of the systolic array of processing elements to perform orthogonal frequency-division multiplexing (OFDM).

FIG. 14 is a diagram showing a more detailed mapping of the systolic array of processing elements to perform OFDM.

FIG. 15 is a diagram showing a high level mapping of the systolic array of processing elements to perform minimum mean square error multiple-input multiple output detection.

FIG. 16 is a diagram showing a more detailed mapping of the systolic array of processing elements to perform minimum mean square error multiple-input multiple output detection.

Corresponding reference numerals indicate corresponding parts throughout the several views of the drawings.

### DETAILED DESCRIPTION

Example embodiments will now be described more fully with reference to the accompanying drawings.

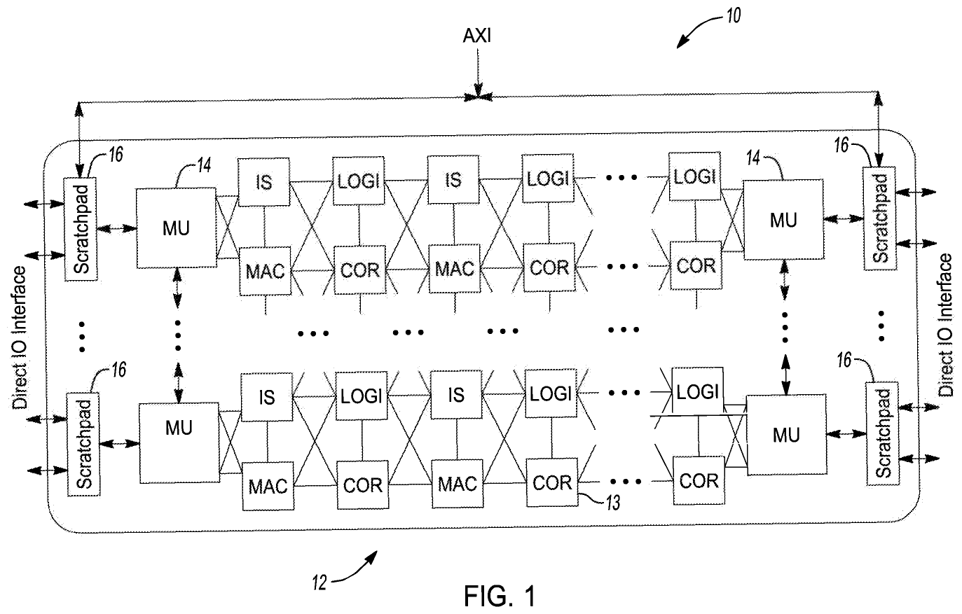

FIG. 1 depicts a top-level architecture for a domain adaptive computer processor 10 in accordance with this disclosure. The computer processor 10 is comprised of a systolic array of processing elements 12 connected to at least one set of management units (MUs) 14. In the example embodiment, a set of management units is placed on opposing sides of the systolic array of processing elements. The management units 14 are used to move data into and out of the systolic array of processing elements 12. Each set of management units 14 is also connected to a scratchpad memory 16 which is in turn connected to an AXI bus for external host interface. Each scratchpad memory may be further defined as 32 banks of 8 kB storage units. Other arrangements for the scratchpad are contemplated by this disclosure.

In the systolic array of processing elements, an individual processing element 13 can be configured to perform different operations. In the example embodiment, the four different types of processing elements includes: complex multiply and accumulate (MAC), intelligent storage (IS), CORDIC and division (COR-DIV) and LOGICAL. The processing elements support 32-bit fixed point complex numbers and communicate with their neighbors in all 8 directions and can be individually clock gated. Each processing element operates in four states: LOAD for loading program into instruction memory (IMEM), EXECUTE for program execution, ROUTE for acting as a programmable router, and IDLE.

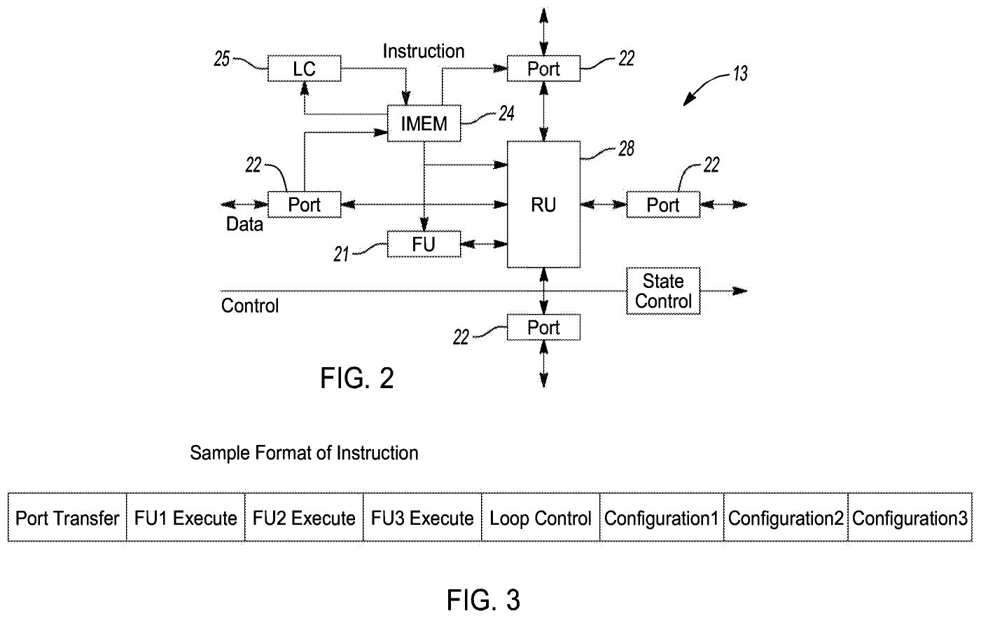

An example implementation for a processing element 13 in the systolic array of processing elements is further described in relation to FIG. 2. Each processing element 13 is comprised of one or more functional units (FUs) 21, at least four ports 22, at least one register (not shown), an instruction memory 24 and a loop control unit 25. Each of these components of the processing element 13 is further described below.

During operation, communication kernels rely on data streaming operations with little or no control flow where a single functional unit is executed continuously or periodically for many cycles, streaming data into other functional units in a highly deterministic manner. Hence, traditional cycle upon cycle instruction fetch and decode is eliminated. Instead, the domain adaptive computer processor 10 utilizes stream instructions that simultaneously specifies the data flow configuration (crossbars and queues) and the operation of FUs (which are enabled or not) as well as loop control which specifies how many cycles the configuration stays in place. Hence, a single instruction can stay in place for many cycles, greatly minimizing control overhead and code size. Further, data is streamed from one functional unit, through a storage register or queue, to another functional unit in a single cycle. Streaming data from a functional unit in one PE to a functional unit in neighbor PE takes two cycles, greatly improving PE to PE communication efficiency compared to network-on-chip architectures which must decode address headers and execute routing algorithms. Since instruction fields are directly copied into the control registers, instruction decode overhead is essentially eliminated and since embedded loop control greatly reduces program size, the entire domain adaptive computer processor 10 can be programmed in 100's of cycles (sub-μs), allowing on-the-fly kernel swapping (unlike FPGAs), allowing simultaneous support of multiple protocols that share processing elements in a time multiplexed fashion.

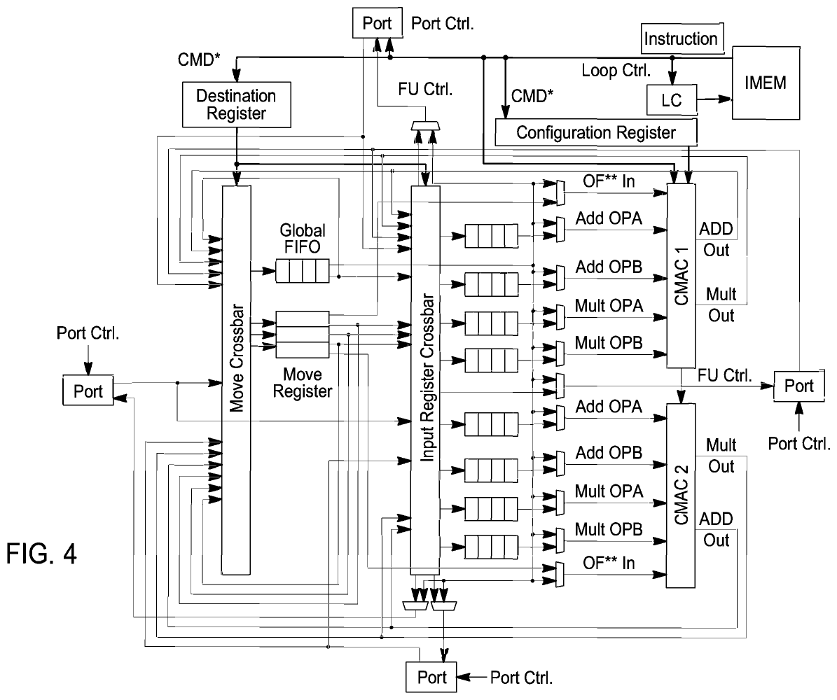

The instruction memory 24 stores instructions for a processing element. Each instruction specifies an operation to be performed by the processing element. To enable different types of operations, each instruction supports multiple types of data elements. For example, the operation to be performed may be defined by one or more of: an operating mode for the one or more functional units, a configuration for the data flow between components comprising the processing element, a data transfer via one of the ports, and/or a number of cycles the configuration is implemented by the processing element. FIG. 3 illustrates an example data format for an instruction. In this example, the instruction may specify up to three different configurations, an operating mode for up to three different functional units (i.e., FU1, FU2 and FU3), a data transfer, a loop control command or a combination thereof. That is, each instruction may include values for only a subset of the data elements. This data format is merely exemplary and it is understood that more or less data elements as well as different types of data elements can be specified by an instruction.

The loop control unit 25 is configured to retrieve a portion of a given instruction from the instruction memory 24 and coordinate execution of the given instruction according to the number of cycles specified by the given instruction. In the example embodiment, the loop control unit 25 coordinates execution up to three nested loops although more or less nested loops can also be supported. Each loop is a set of sequentially executed instructions.

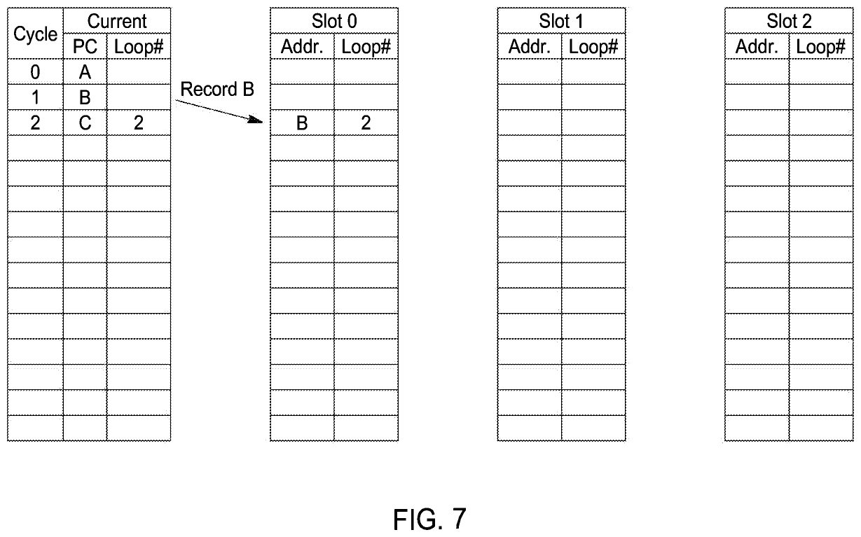

Referring to FIGS. 5-11, a nested loop control technique is described in more detail. Three shift registers are used by the loop control unit 25 to record a return address and the remaining number of loop iterations as seen in FIG. 5. When entering a new loop, the return address and the loop number is shifted right in the registers; whereas, when loop number reaches zero, the return address and the loop number is shifted back to the left in the registers. Although more or less nested loops may be supported, three nested loops was found sufficient for a wide range of communication kernels.

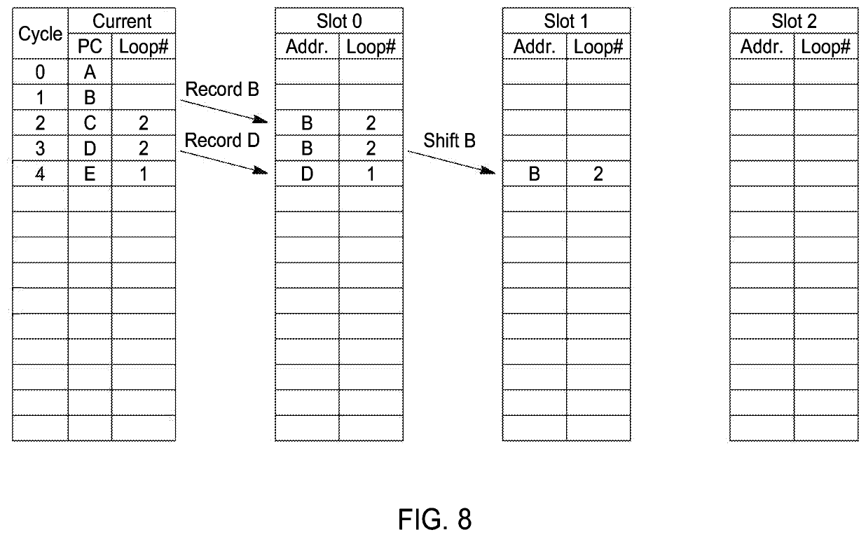

For illustration purposes, a sequence of instructions is shown in FIG. 6, where each instruction is shown with a value for its loop command.

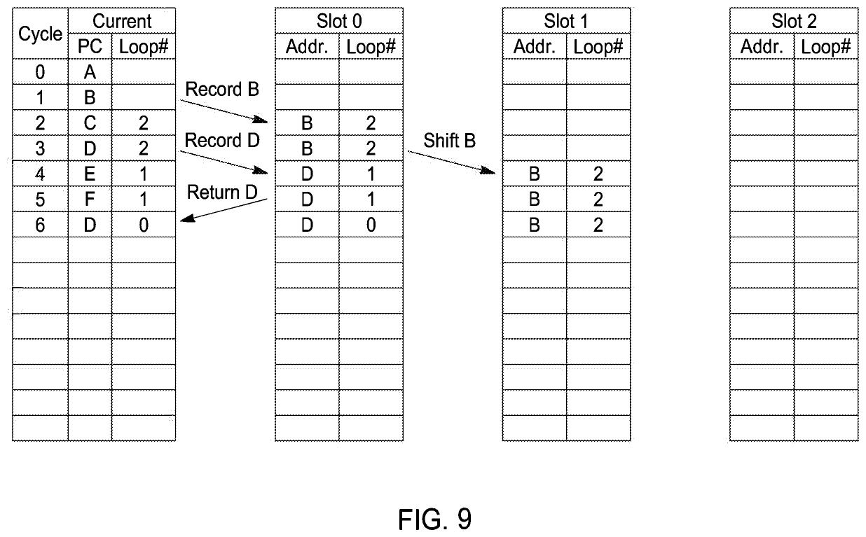

After executing instruction A, instruction B starts an outer loop having three iterations. To do so, the loop control unit 25 records a return address for instruction B and a loop number in the first register as seen in FIG. 7, where the recorded loop number (i.e., value of 2) is the loop number from the instruction (i.e., value of 3) decremented by one. Instruction C is then executed.

Instruction D starts an inner loop as seen in FIG. 8. In this instance, the loop control unit 25 first shifts the return address for instruction B and the loop number 2 from the first register to the second register. The loop control unit 25 then records a return address for instruction D and a loop number in the first register, where the recorded loop number (i.e., value of 1) is the loop number from the instruction (i.e. value of 2) decremented by one. Instruction E is then executed.

Instruction F causes an iteration of the inner loop. With reference to FIG. 9, the return address for instruction D is shifted back to the current execution register and the loop number is decremented by one, i.e., to zero. Instruction E is again executed before returning to Instruction F. Since the loop number is now zero, the inner loop is exited and the return address for Instruction B, along with the loop number, is shifted left from the second register back to the first register as seen in FIG. 10.

Instruction G, the next sequential instruction, is executed before reaching Instruction H. Instruction H causes an iteration of the outer loop, such that the return address for instruction B is shifted back to the current execution register and the loop number is decremented by one, i.e., to one. In FIG. 11, the execution of the outer loop is repeated until the loop number is decremented to zero an the outer loop is exited. This example of nested loop control is intended to be non-limiting.

With continued reference to FIGS. 2 and 3, operation specified by a given instructions may include an operating mode for the one or more functional units. In FIG. 3, an operating mode may be specified for up to three different functional units. In a given processing element, a given functional unit is configured to retrieve portion of the given instruction from the instruction memory and implement the operating mode specified for the given functional unit in the given instruction. That is, a first designated functional unit retrieves the portion of an instruction allocated to the first functional unit and a second designated functional unit retrieves the portion of the instruction allocated to the second functional unit. Different types of functional units have different operating modes. For example, a MAC type functional unit may have operating modes such as addition, subtraction or multiplication; whereas, a CORDIC-DIV type functional unit may have operating modes such as rotation, vectorization or square root. In the example embodiment, the operating modes available for each type of functional unit are as follows. For MAC type, operating modes include but are not limited to addition, subtraction, multiplication, fusion addition, fusion subtraction and real number convolution. For IS type, operating modes include but are not limited to first in first out storage, first in last out storage and random access storage. For COR-DIV type, operating modes include but are not limited to rotation, vectorization, square root, and division. For LOGICAL type, operating modes include but are not limited to maximum, minimum and rectified linear activation. These example operating modes are not intended to be limiting.

Each processing element in the systolic array of processing elements further includes a register unit 28. The register unit 28 is configured to retrieve portion of the given instruction from the instruction memory 24 and implement the configuration for the data flow between components specified in the given instruction. In the example embodiment, types of types of configurations specified in the given instruction include but are not limited to: changing an operating mode of a functional unit, changing dataflow between components, changing loop number, directly writing a value to the at least one register, and directly moving data from the at least one register.

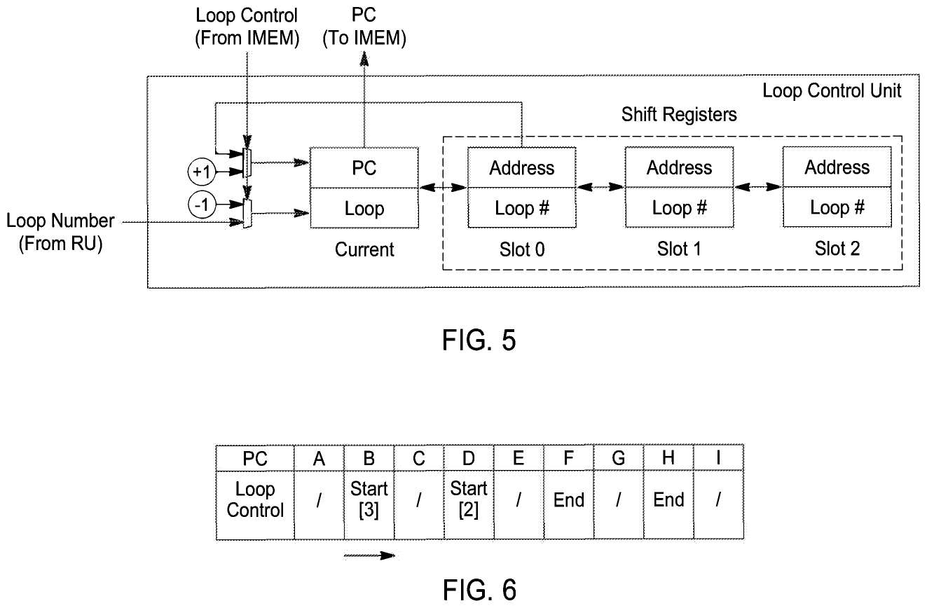

FIG. 4 further depicts an example embodiment for a processing element 13. A conventional CPU or GPGPU typically implements a large number of functional units and registers resulting a large, multi-port register file. In the proposed domain adaptive processor, four functional units per processing element would result in a register file with over 12 ports, which would dominate the power and area consumption of the processing element. Instead, the domain adaptive processor 10 restricts data movement based on common patterns for a wide set of kernels, and handle connections between the functional units with two sequential crossbars 41 that are pre-set with the stream instructions. Inputs to each functional units are directly connected to specific registers (or small queues with 4 entries in the MAC PE) thereby eliminating the need for multiple register outputs. Outputs of the functional units are then connect to the 12-input to 12-output crossbar which allows direct FU-to-FU streaming. In addition, data can be routed to move registers or a global FIFO 42 through a smaller 16-to-4 crossbar to allow additional data storage, data alignment, and broadcast to a selectable set of FU inputs.

In FIG. 4, the processing element is a MAC type with two functional units CMAC1 and CMAC 2. Each functional unit can be reconfigured as either 1 complex-number MAC or 4 real-number MACs. This feature greatly benefits real-valued kernels by providing 4× the number of MAC units (8 total for the MAC PE). Multipliers in the CMAC FU occupy two pipeline stages and adders a single stage. However, the multipliers continue to set the clock frequency leaving adders with significant delay slack. This slack is utilized by adding 2 operation-fused adders which execute in a single cycle with the CMAC adders, providing additional computation without impacting clock frequency. The global scratchpads outside of the PE array and in the IS PEs can be configured into either complex or real number mode by multi-banking.

The domain adaptive processor 10 supports multitasking in which the PE array runs different kernels simultaneously. A dataflow graph of the desired kernels is first broken down into DAP-supported functional units, and connections are then programmed into the intra-and inter-PE datapaths. Different kernels in the same workload can directly interface with each other without moving data in and out of the global scratchpad.

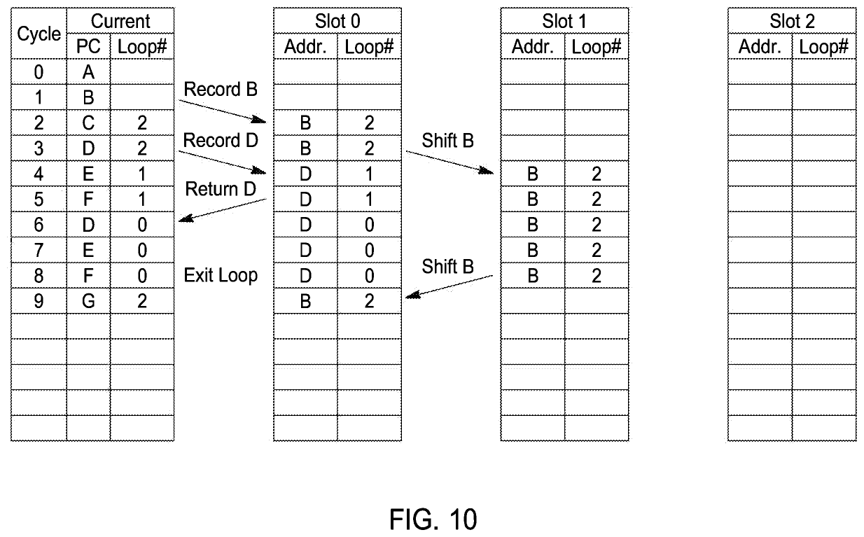

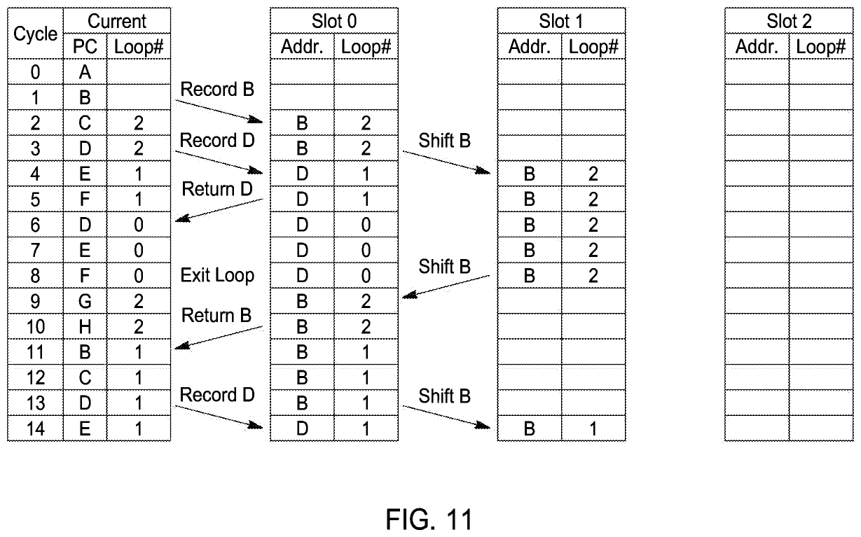

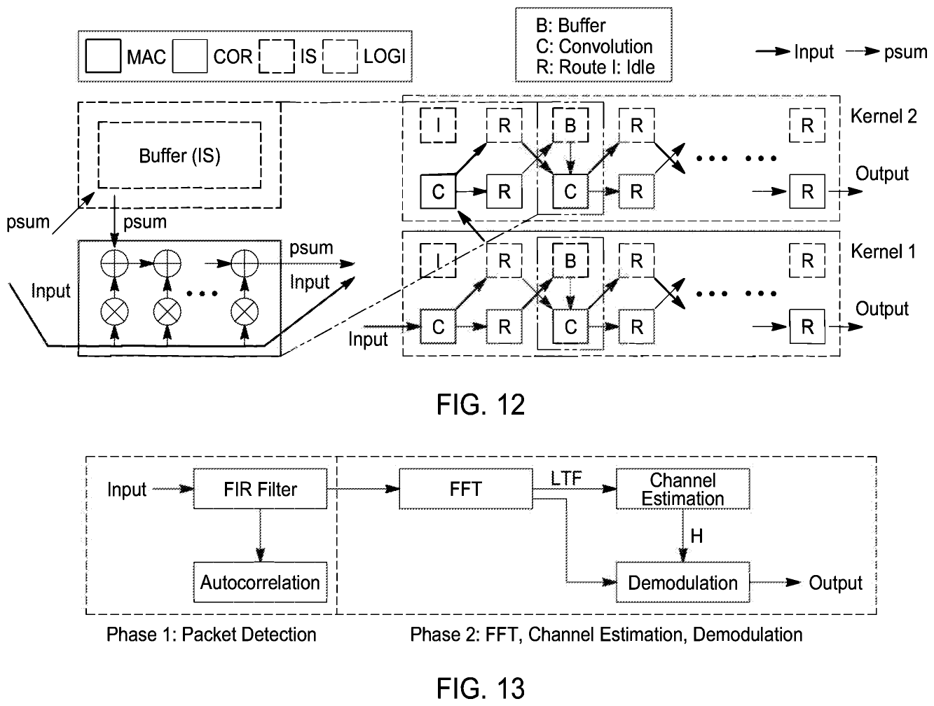

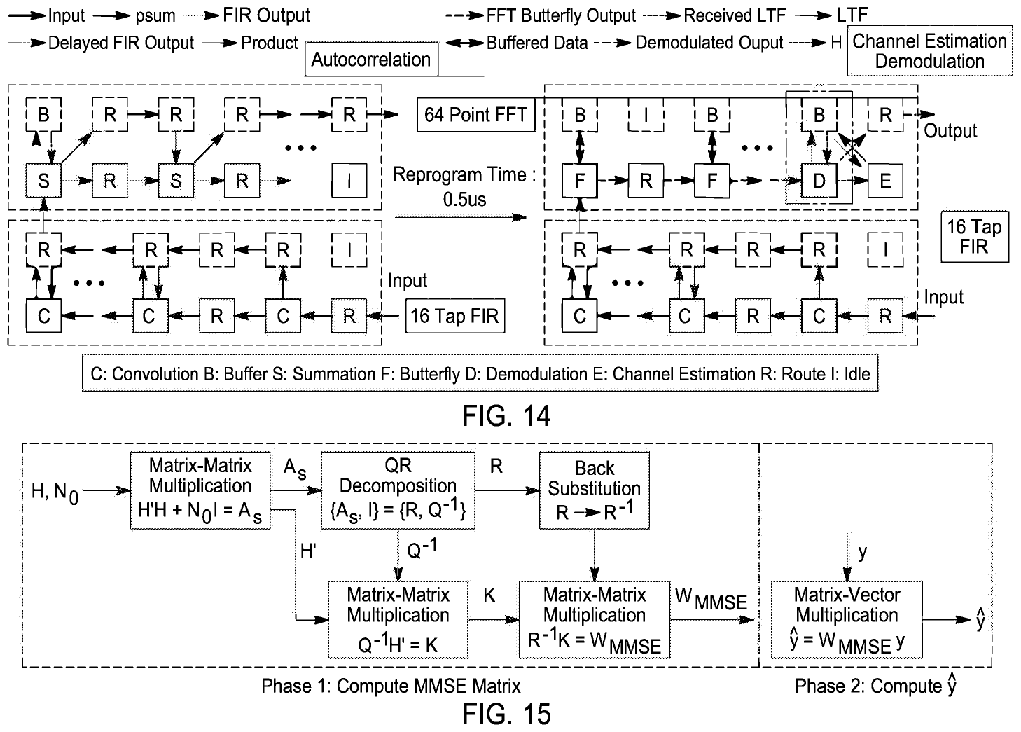

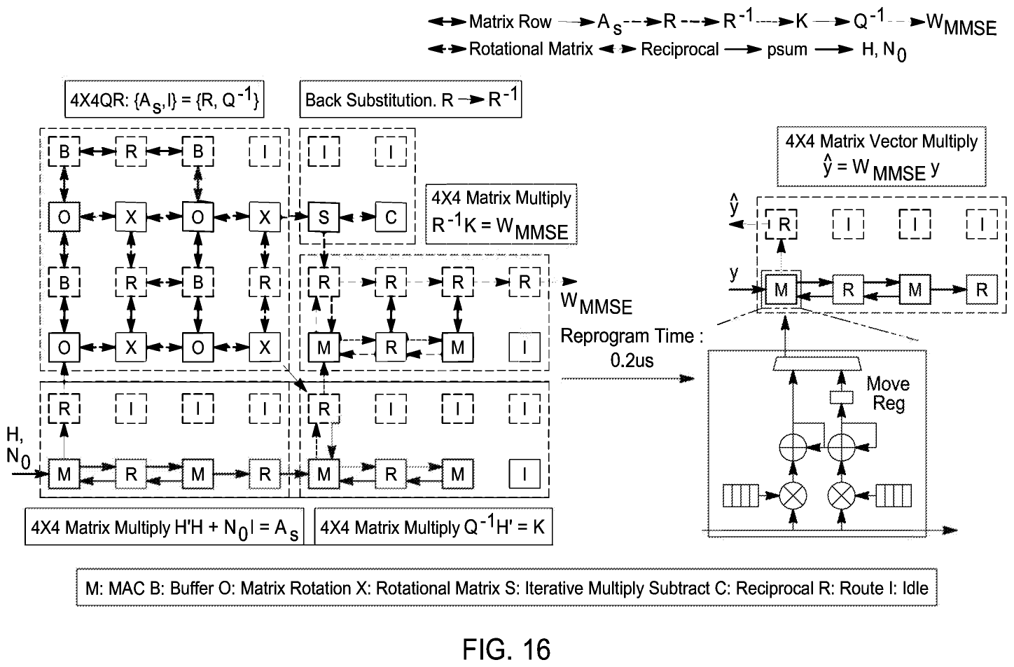

FIGS. 12-16 shows example mappings of 2D convolution, OFDM, and MMSE MIMO detection. There are multiple phases in OFDM; packet detection, channel estimation, and demodulation. For packet detection, the output of FIR is directly used as the autocorrelation input without leaving the PE array. Upon packet detection, the domain adaptive processor 10 can be reprogrammed within 0.5 us to reuse the same PEs for channel estimation, FFT, and symbol demodulation. DAP's ability to merge and seamlessly connect different kernels largely eliminates scratchpad access overhead. MIMO detection is combination of multiple kernels including QR decomposition, matrix multiplication, and back substitution. After computing the MMSE matrix and PEs are reprogramed (0.2 us latency) to perform matrix vector multiplication. In this mapping, no IS PE is required since an entire matrix is stored in the queues connected to the CMAC.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A domain adaptive computer processor, comprising:
at least one set of management units; and
a systolic array of processing elements connected to the at least one set of management units, wherein each processing element in the systolic array of processing elements includes
one or more functional units;
at least four ports for passing data between adjacent processing elements;
at least one register interfaced with the one or more functional units;
an instruction memory that stores instructions, where each instruction specifies an operation to be performed by the processing element and the specified operation is defined by a configuration for the data flow between components comprising the processing element, and a number of cycles the configuration is implemented by the processing element; and
a loop control unit configured to retrieve portion of a given instruction from the instruction memory and coordinate execution of the given instruction according to the number of cycles specified by the given instruction.

2. The domain adaptive computer processor of claim 1 wherein the loop control unit coordinates execution of two or more loops, where each loop is a set of sequentially executed instructions.

3. The domain adaptive computer processor of claim 1 wherein each processing element in the systolic array of processing elements further includes a register unit, where the register unit is configured to retrieve portion of the given instruction from the instruction memory and implement the configuration for the data flow between components specified in the given instruction.

4. The domain adaptive computer processor of claim 3 wherein types of configurations specified in the given instruction are selected from a group consisting of changing an operating mode of a functional unit, changing dataflow between components, changing loop number, directly writing a value to the at least one register, and directly moving data from the at least one register.

5. The domain adaptive computer processor of claim 1 wherein the specified operation is further defined by an operating mode for the one or more functional units.

6. The domain adaptive computer processor of claim 5 where a given functional unit of a given processing element is configured to retrieve portion of the given instruction from the instruction memory and implement the operating mode specified for the given functional unit in the given instruction.

7. The domain adaptive computer processor of claim 5 wherein the operating modes specified by an instruction are selected from a group consisting of addition, subtraction, multiply, division, a storage operation, a CORDIC operation and a Boolean operation.

8. The domain adaptive computer processor of claim 1 wherein each processing element further includes two crossbars, where the two crossbars interconnect the one or more functional units with the at least one register.

9. A domain adaptive computer processor, comprising:
at least one set of management units; and
a systolic array of processing elements connected to the at least one set of management units, wherein each processing element in the systolic array of processing elements includes
one or more functional units;
at least four ports for passing data between adjacent processing elements;
at least one register interfaced with the one or more functional units;
an instruction memory that stores instructions, where each instruction specifies an operation to be performed by the processing element and the specified operation is defined by a configuration for the data flow between components comprising the processing element, and a number of cycles the configuration is implemented by the processing element; and
a loop control unit configured to retrieve portion of a given instruction from the instruction memory and coordinate execution of the given instruction according to the number of cycles specified by the given instruction
wherein types of configurations specified in the given instruction are selected from a group consisting of changing an operating mode of a functional unit, changing dataflow between components, changing loop number, directly writing a value to the at least one register, and directly moving data from the at least one register.

10. The domain adaptive computer processor of claim 9 wherein the loop control unit coordinates execution of two or more loops, where each loop is a set of sequentially executed instructions.

11. The domain adaptive computer processor of claim 9 wherein each processing element in the systolic array of processing elements further includes a register unit, where the register unit is configured to retrieve portion of the given instruction from the instruction memory and implement the configuration for the data flow between components specified in the given instruction.

12. The domain adaptive computer processor of claim 9 wherein the specified operation is further defined by an operating mode for the one or more functional units.

13. The domain adaptive computer processor of claim 12 where a given functional unit of a given processing element is configured to retrieve portion of the given instruction from the instruction memory and implement the operating mode specified for the given functional unit in the given instruction.

14. The domain adaptive computer processor of claim 12 wherein the operating modes specified by an instruction are selected from a group consisting of addition, subtraction, multiply, division, a storage operation, a CORDIC operation and a Boolean operation.

15. The domain adaptive computer processor of claim 9 wherein each processing element further includes two crossbars, where the two crossbars interconnect the one or more functional units with the at least one register.

16. A domain adaptive computer processor, comprising:
at least one set of management units; and
a systolic array of processing elements connected to the at least one set of management units, wherein each processing element in the systolic array of processing elements includes
one or more functional units;
at least four ports for passing data between adjacent processing elements;
at least one register interfaced with the one or more functional units;
an instruction memory that stores instructions, where each instruction specifies an operation to be performed by the processing element and the specified operation is defined by a configuration for the data flow between components comprising the processing element, and a number of cycles the configuration is implemented by the processing element; and
a loop control unit configured to retrieve portion of a given instruction from the instruction memory and coordinate execution of the given instruction using three shift registers and according to the number of cycles specified by the given instruction, where the three shift registers record a return address and a number of loop iterations.

17. The domain adaptive computer processor of claim 1 wherein the loop control unit right shifts data in the three shift registers upon entering a new loop and left shifts the data in the three shift registers when the number of loop iterations reaches zero.

18. The domain adaptive computer processor of claim 16 wherein each processing element in the systolic array of processing elements further includes a register unit, where the register unit is configured to retrieve portion of the given instruction from the instruction memory and implement the configuration for the data flow between components specified in the given instruction.

19. The domain adaptive computer processor of claim 18 wherein types of configurations specified in the given instruction are selected from a group consisting of changing an operating mode of a functional unit, changing dataflow between components, changing loop number, directly writing a value to the at least one register, and directly moving data from the at least one register.
